(19) United States
(12) Patent Application Publication
(10) Pub. No.: US 2008/0260628 A1
(43) Pub. Date: Oct. 23, 2008

(54) Ni-based catalyst for tri-reforming of methane and its catalysis application for the production of syngas

(75) Inventors: Dong Ju Moon, Seoul (KR); Jung Shik Kang, Seoul (KR); Won Seok Nho, Anyang-si (KR); Dae-Hyun Kim, Seoul (KR); Sang Deuk Lee, Seoul (KR); Byung Gwon Lee, Seoul (KR)

Correspondence Address: FROMMER LAWRENCE & HAUG, 745 FIFTH AVENUE- 10TH FL., NEW YORK, NY, 10151, US

(73) Assignee: KOREA INSTITUTE OF SCIENCE AND TECHNOLOGY

(21) Appl. No.: 11/787,555

(22) Filed: Apr. 17, 2007

(51) Int. Cl. B01J 23/10; C01B 3/02

(52) U.S. Cl. 423/648.1; 502/303

(57) ABSTRACT

The present invention relates to a Ni-based catalyst for preparing syngas and a tri-reforming reaction of methane using the catalyst, particularly to a Ni-based catalyst, where an active ingredient (a nickel) is impregnated in a zirconia support and the zirconia is doped with a yttrium and a metal selected among a lanthanum and an alkaline earth metal to distort the crystal lattice of the zirconia, to facilitate the transfer of oxygen ion and to increase the storage and supply of oxygen, thus inhibiting the carbon deposition on the active nickel metal and maintaining the activity of the catalyst. Particularly, if the catalyst herein is used for the tri-reforming reaction of methane where a mixture of carbon dioxide, oxygen and steam is used as an oxidant, the molar ratio of hydrogen and carbon monoxide (H₂/CO) in the syngas may be selectively controlled.

### TECHNICAL FIELD

The present invention relates to a Ni-based catalyst for preparing syngas and a tri-reforming reaction of methane using the catalyst, and particularly to a Ni-based catalyst, where an active ingredient (a nickel) is impregnated in a zirconia support and the zirconia is doped with a yttrium and a metal selected among a lanthanum and an alkaline earth metal to distort the crystal lattice of the zirconia, to facilitate the transfer of oxygen ion and to increase the storage and supply of oxygen, thus inhibiting the carbon deposition on the active nickel metal and maintaining the activity of the catalyst. Particularly, if the catalyst herein is used for the tri-reforming reaction of methane where a mixture of carbon dioxide, oxygen and steam is used as an oxidant, the molar ratio of hydrogen and carbon monoxide (H₂/CO) in the syngas may be selectively controlled.

### RELATED PRIOR ART

Oxygen, steam, carbon dioxide or a mixture thereof has been used as an oxidant to prepare syngas from hydrocarbon. Various catalysts have been developed depending on the kind of the oxidant.

Examples of a reforming reaction of methane to prepare syngas are a steam reforming reaction, a carbon dioxide reforming reaction, a partial oxidation reforming reaction and an autothermal reforming reaction.

The steam reforming reaction of methane proceeds as described in Scheme 1, and Ni-based catalyst is usually used in this reaction.

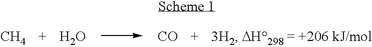

The deactivation of catalyst due to the carbon deposition on the catalyst is a serious problem in the steam reforming reaction. Excess steam is added to overcome this problem. Various promoters have been attempted to be added to Ni-based catalyst to solve the problem of carbon deposition.

To suggest a reforming catalyst superior to a conventional Ni-based catalyst for steam reforming, U.S. Pat. No. 4,026,823 discloses a Ni-based catalyst supported in zirconia added with cobalt. U.S. Pat. Nos. 4,297,205 and 4,240,934 disclose a catalyst for reforming hydrocarbon where iridium is supported in a complex support of zirconia and alumina.

The carbon dioxide reforming reaction of methane proceeds as described in Scheme 2. Ni-based catalyst and noble metal based catalyst are usually used in this reaction.

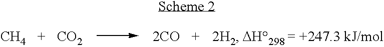

Syngas with high carbon monoxide content (H₂:CO=1:1) may be prepared by performing a reaction using carbon dioxide. The produced syngas may be utilized in manufacture of dimethyl ether (DME). However, expensive noble metal based catalyst has been suggested to be used because of the serious deactivation of catalyst caused by carbon deposition. For example, U.S. Pat. No. 5,068,057 discloses Pt/ Al₂O₃ and Pd/Al₂O₃ catalysts. WO 92/11,199 discloses that alumina catalyst supported by noble metal such as iridium, rhodium and ruthenium has superior in activity and durability. However, despite the superior in activity and resistance to carbon deposition, the noble metal based catalyst is too expensive and inappropriate to be applied to industry as compared to the Ni-based catalyst.

Japanese Patent Application Publication No. 11-276893 discloses a reforming reaction of methane using carbon dioxide on a metal oxide catalyst of hydrotalcite derivative containing noble metal (Rh, Pd, Ru) and transition metal (Ni) as an active metal. However, although the conversion of methane is greater than 90% at 800° C., it decreases drastically as the temperature decreases down to less than 30% at 600° C. except that a catalyst containing 5 wt % of rhodium shows about 50%.

Therefore, it is important to use a transition metal instead of a noble metal for the preparation of metal oxide catalyst of hydrotalcite derivative to be used in a hydrocarbon reforming reaction and also to optimize the content of the catalyst for maximizing its catalytic activity.

In this regard, many attempts have been made to develop a low-priced nickel-supported catalyst with high performance with superior resistance to carbon deposition in the reforming reaction of methane using carbon dioxide like in the steam reforming reaction.

The partial oxidation reaction of methane proceeds as described in Scheme 3. Although this reaction is advantageous in preparing syngas with high hydrogen content due to rapid deactivation of the catalyst caused by the perfect combustion of methane as shown in Scheme 4.

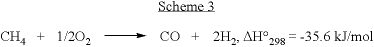

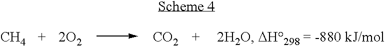

The tri-reforming reaction of methane proceeds as described in Scheme 5. This reaction may variously control the molar ratio of syngas (H₂/CO) in the range of 1-2 by using a mixture of carbon dioxide, oxygen and steam as an oxidant. This reaction is likely to be commercialized as a technique to produce a low-priced syngas in which the carbon deposition on the catalyst is inhibited by this reaction.

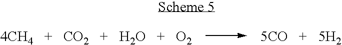

Recently, Song et al. suggested a process of the tri-reforming reaction of methane [C. Song, W. Pan, Catal. Today 98 (2004) 46] as a carbon dioxide reduction and sequestration technology. However, there is a serious problem of catalyst deactivation when the tri-reforming reaction of methane is performed on the commercial ICI catalyst although the conversions of carbon dioxide and methane are 65% and 90%, respectively and the molar ratio of H₂/CO is 1.5-2.2. Lee et al. reported that the conversion of carbon dioxide and methane was 85% and 95%, respectively, keeping molar ratio of H₂/CO to be 1-1.8 during the tri-reforming reaction of methane over Ni/Ce—ZrO₂ based catalyst for the production of syngas [S. H. Lee, W. C. Cho, W. S. Ju, B. H. Cho, Y. C. Lee, Y. S. Baek, Catal. Today 84 (2003) 133].

The present inventors have exerted extensive researches to develop a catalyst that is capable of overcoming the aforementioned carbon deposition, during the conventional the tri-reforming reaction of methane using a mixture of carbon dioxide, oxygen and steam as an oxidant, while increasing the conversions of methane and carbon dioxide and selectively controlling H₂/CO molar ratio.

The inventors found as a result that the yttrium distorts the crystal lattice of the zirconia, thereby facilitating the transfer of oxygen ion and increasing the storage and supply of oxygen, thus inhibiting the carbon deposition on the active nickel metal, maintaining the activity of the catalyst and selectively controlling the molar ratio of hydrogen and carbon monoxide (H₂/CO) in the syngas, when the tri-reforming reaction of methane is performed on a Ni-based catalyst, where an active ingredient (a nickel) is supported in a zirconia support and the zirconia is doped with a yttrium and a metal selected among a lanthanum and an alkaline earth metal. The present invention has been completed based on the aforementioned findings.

Therefore, an objective of the present invention is to provide a Ni-based catalyst for preparing syngas, where nickel active metal is supported on a zirconia doped with yttrium and lanthanum and/or alkaline earth metal, and a tri-reforming reaction of methane using the catalyst.

### DETAILED DESCRIPTION OF INVENTION

The present invention relates to a Ni-based catalyst of Formula (1) for the tri-reforming reaction of methane, which comprises yttrium (Y) as an essential ingredient, wherein a nickel metal is supported by a zirconia support doped with the yttrium (Y) and a metal selected among a lanthanum and an alkaline earth metal:

Ni/(Y,ZrO₂—M) (1)

where Ni is an active metal in the range of 0.5-10 wt % relative to ZrO₂; Y is an essential metal for doping the zirconia in the range of 5-10 mol % relative to the zirconia; and M is at least one metal selected among an lanthanum and an alkaline earth metal, particularly Ce, Ti, Si, Mg and Ca in the range of 0.5-10 wt % relative to ZrO₂.

The present invention also relates to a process for producing syngas, which comprises the step of performing a tri-reforming reaction of methane by supplying a mixture of carbon dioxide, steam and oxygen onto the Ni-based catalyst of Formula (1) under the conditions of 650-850° C., 0.5-10 atm and 1,000-300,000 h⁻¹ of space velocity, thereby inhibiting the carbon deposition, improving the performance of the catalyst and selectively controlling the H₂/CO molar ratio to 0.5-2.

Hereunder is provided a detailed description of the present invention.

The present invention relates to a catalyst for the tri-reforming reaction of methane, wherein an active ingredient, nickel metal, is supported by a zirconia support doped with the yttrium (Y) and a metal selected among a lanthanum and an alkaline earth metal and a process for producing syngas using the catalyst.

Korean Patent Application Publication Nos. 2002-0021721, 2002-0026074 and 2004-0051953 disclose a nickel catalyst where a nickel metal is supported on zirconia doped with alkaline earth metal and lanthanum metal. However, these catalysts were applied only to the steam reforming reaction of methane and the carbon dioxide. These catalysts have never been applied or indicated to be applicable to the tri-reforming reaction of methane using a mixture of carbon dioxide, oxygen and steam.

It is obvious to the one skilled in the art that the conversion of hydrocarbon and the syngas contents may vary depending on the type of reforming reaction for manufacturing syngas even though the same catalyst is used. Further, the catalyst herein is fundamentally different from the conventional catalyst in that the amount of nickel active metal is predetermined and that the zirconia support is doped with yttrium and metal selected among lanthanum and alkaline earth metal. Moreover, the tri-reforming reaction of methane employed herein is also fundamentally different from each of the steam reforming reaction, the partial oxidation reforming reaction using oxygen and the reforming reaction using carbon dioxide in that syngas is produced in the present invention as the aforementioned reactions proceed in combination. For this reason, a catalyst similar to the catalyst herein does not show a similar effect when applied to different reaction as described in Comparative Examples.

As shown above, the support used to prepare the Ni-based catalyst herein is zirconia doped with yttrium and a metal selected among lanthanum and alkaline earth metal. This support serves as a promoter to increase the activity of a nickel metal. More particularly, the yttrium intercalates the crystal lattice of zirconia to deform the lattice, thereby facilitating the transfer of an oxygen ion. As a result, a carbon deposited on the surface of nickel reacts with an oxygen ion supplied from the support as well as gas-phased oxygen, and transforms into carbon monoxide or carbon dioxide, thus being separated from the surface of the nickel. This inhibits the carbon deposition and improves the catalytic activity as compared to the commercial HT catalyst. Although yttrium is reported to be contained in an alumina support as an active ingredient, the present invention is different from this report in that (i) yttrium is used for a different purpose, i.e. as a doping component herein and that (ii) the yttrium-doped support functions as a promoter in the reforming reaction. In lanthanum and alkaline earth metal, i.e. metals doping the zirconia, cerium and magnesium are preferred, respectively, because these metals have advantages in storing or supplying oxygen ions and inhibiting carbon deposition.

Hereunder is provided a detailed description of the contents of Ni-based catalyst for reforming reaction of methane.

Yttrium, which dopes zirconia and increases the mobility of oxygen ion, is contained in the amount of 5-10 mol % relative to zirconia. If the amount is less than 5 mol %, the lattice of zirconia may not be deformed and the mobility of oxygen ion may not be sufficient. If the amount is greater than 10 mol %, the activity of catalyst in the tri-reforming reaction of methane may be decreased due to over-deformation of zirconia lattice. Generally, zirconia has a metastable tetrahedral structure at a temperature less than 400° C. With the increase in temperature, zirconia undergoes the transformation into more stable monoclinic structure. During the transformation, crack may be formed in the surface of particles, and this may cause the decrease in the surface area and the transferability of oxygen ion. Thus, Kim et al. [Kim et. at., J. of Membrane Science 139, (1998) 75] reported that the use zirconia at a relatively high temperature requires a step of stabilizing zirconia to prevent the transformation. According to this report, zirconia having fluorite structure, a structure stable at high temperature, may be obtained by adding 8 wt % of yttria. Moreover, Kim et al. reported that the thermal stability is secured along with the increase in the ionic conductivity of oxygen from room temperature to 1,000° C. This tendency reported was found to be affected by the addition of molar concentration on yttria added in zirconia, the addition of 8 mol % yttria exhibited the highest ionic conductivity of oxygen.

The content of lanthanum and alkaline earth metal used to increase the activity and stability of a catalyst along with yttrium, may be in the range of 0.5-10 wt %, preferably 1.5-3 wt %, respectively, relative to zirconia. If the amount is less than 0.5 wt %, the carbon deposition may seriously happen on the surface of nickel. If the nickel content is greater than 10 wt %, the activity of a catalyst may decrease. Further, lanthanum alone, alkaline earth metal alone or a combination thereof may be used. When the combination is used, a mixture containing 1-5 wt % each of lanthanum and alkaline earth metal relative to zirconia is preferred. If the content of lanthanum or alkaline earth metal is less than 1 wt %, the role as a promoter may not be sufficiently performed. If the amount is greater than 5 wt %, the activity of catalyst may be decreased.

Components such as titanium dioxide and silica may be further added in the catalyst herein to increase the thermal stability of the catalyst as reported previously [D. Skarmoutsos, F. Tietz and P. Nikolopoulos FUEL CELLS 1(2001) 3]. The additional components may be added within the range herein, preferably within 5-15 wt % relative to zirconia.

The catalyst is prepared by impregnating a nickel active metal in the doped zirconia support. The metal active nickel is contained in the amount of 0.5-10 wt %, preferably 0.5-2 wt %, relative to zirconia. If the amount is less than 0.5 wt %, the reactivity of the catalyst for the tri-reforming reaction of methane may be decreased. If the content of nickel is greater than 10 wt %, the heavy deposition of carbon may occur on the surface of nicke.

The Ni-based catalyst for the tri-reforming reaction of methane may be prepared by using the conventional method such as a co-precipitation method, a physical mixing method, a sol-gel method, a fusion method and the impregnation method. The doped zirconia support herein may be prepared by using a co-precipitation method, an impregnation method and a physical mixing method. Active ingredient and promoter may be impregnated by using an impregnation method and a co-precipitation method.

For example, hereunder is provided a description of the impregnation method to impregnate nickel active metal and co-catalytic component such as yttrium, lanthanum and alkaline earth metal in the zirconia support.

First, zirconia support powder and promoter powder selected among yttrium and lanthanum and/or alkaline earth metal are dispersed in distilled water and alcohol, and mixed to form a slurry. An aqueous solution of nickel nitrate salt (1-2 M) is added in the slurry depending on the predetermined impregnating amount, and then dried at about 60° C. for 6-7 h for removing water and alcohol. The slurry is dried in an oven (100° C.) for 12 h and calcined in a furnace (800-1350° C.) in the air for 2 h, thereby providing a Ni-based catalyst.

The aforementioned methods are meant only to illustrate the present invention, and other methods than described above may be used to prepare the Ni-based catalyst.

Meanwhile, syngas may be manufactured over thus prepared Ni-based catalyst through the tri-reforming reaction of methane, where carbon dioxide, oxygen and steam are supplied simultaneously.

A conventional fixed bed catalyst reactor is used in the present invention to measure the activity of the Ni-based catalyst for the tri-reforming reaction of methane.

First, a predetermined amount of Ni-based catalyst is filled into a reactor for the pre-treatment of a catalyst before performing reaction, followed by a process of reduction at 800° C. for 1 h by supplying under hydrogen flow. The tri-reforming reaction of methane was proceeded at 650-850° C., 0.5-10 atm and a space velocity of 1,000-300,000 h⁻¹, while supplying carbon dioxide, oxygen and steam at the same time. The molar ratio of carbon dioxide, oxygen and steam may be 0.5-2.0 moles, 0.05-1.0 mole and 0.5-2.0 moles, respectively, relative to 1 mole of methane.

For example, the mixture is provided in a reactor so that the molar ratio of methane:carbon dioxide:steam:oxygen may be 1:1:1:0.1, when performing an experiment to increase the yield of carbon monoxide in the product. The molar ratio may be 1:0.5:1:0.1 in an experiment to increase the yield of hydrogen.

During the reaction, the temperature was controlled using an electric furnace and a programmable PID(proportional, integral and derivative) temperature controller. Flow rate of reactants was controlled using a mass flow controller as the tri-reforming reaction of methane proceeds. After the reaction, the activity of the catalyst is investigated by analyzing syngas contents by a gas chromatograph (on-line GC) connected directly to the reactor.

As described above, when the tri-reforming reaction of methane is performed using novel Ni-based catalyst herein, the conversion of methane increase by about 20% as compared to the dry reforming reaction of methane using carbon dioxide. Further, the carbon deposition is inhibited and the activity and durability of catalyst are improved. Furthermore, the molar ratio of carbon monoxide and hydrogen in syngas may be selectively controlled by controlling the content and amount of reactant gas. Particularly, the molar ratio of hydrogen:carbon monoxide may be maintained within the range of 1:0.5-2.0.

### BRIEF DESCRIPTION OF DRAWINGS

FIG. 1 schematically shows a process of the tri-reforming reaction of methane according to the present invention.

| | | | | | |
|---|---|---|---|---|---|
| 1. | Mass flow | 2. | Needle valve | 3. | Water |
| | controller | | | | |
| 4. | Liquid pump | 5. | H₂O | 6. | Electrical heater |
| | | | evaporator | | |
| 7. | Line mixer | 8. | Thermocouple | 9. | Tri-reforming reactor |
| 10. | Temperature | 11. | Cooler | 12. | Water trap |
| | controller | | | | |
| 13. | 6-Port sampling | 14. | Gas | 15. | Computer |
| | valve | | chromatograph | | |

FIG. 2 is a graph which compares the contents of carbon dioxide, methane and post-reaction syngas as a function of temperature in the case of the tri-reforming reaction of methane (a) and the carbon dioxide reforming reaction of methane (b) over Ni/(8Y, ZrO₂—CeO₂) catalyst.

FIG. 3 is a graph which shows the conversion of methane as a function of the molar ratio of yttrium (Y) in the tri-reforming reaction of methane over Ni/(Y,ZrO₂—CeO₂) catalyst.

FIG. 4 is a graph which compares the results of thermogravimetry (TG) and differential thermal analysis (DTA) of a catalyst after the tri-reforming reaction of methane (a) and the carbon dioxide reforming reaction of methane (b) performed over Ni/(8Y, ZrO₂—CeO₂) catalyst.

FIG. 5 is a graph which compares the content of syngas prepared in the tri-reforming reaction of methane performed on Ni/(8Y, ZrO₂—CeO₂) catalyst, commercial catalysts from HT Company and ICI Company.

FIG. 6 is a graph which compares the durability of catalyst after the tri-reforming reaction of methane performed over Ni/(8Y, ZrO₂—CeO₂) catalyst and commercial catalyst from HT Company.

### EXAMPLES

The present invention is described more specifically by the following Examples. Examples herein are meant only to illustrate the present invention, but they should not be construed as limiting the scope of the present invention.

### Preparatory Example 1

### Preparation of Support (Y, ZrO₂—M)

Predetermined amounts of ZrO₂, YO₂ and MOₓ powders were mixed as shown in Table 1, and 7 vol % of water relative to the volume of the powder mixture, thereby providing slurry. Zirconia balls (0.2 mm) were added into the slurry in the amount of 10-20 times the weight of the slurry, followed by ball-milling mixing and pulverization of the slurry for 24 h. After zirconia balls were removed, solvent was evaporated in an oven (100° C.), thereby providing (Y, ZrO₂—M) support.

TABLE 1

| | Support (Y,ZrO₂-M) | | |
|---|---|---|---|
| | Molar ratio of | Weight ratio of | |
| | Y relative | M relative to | |
| Support | ZrO₂ (mol %) | ZrO₂ (wt %) | Produced Support |
| 1 | (8) | Ce (6) | 8Y,ZrO₂-CeO₂ |
| 2 | (3) | Ce (6) | 3Y,ZrO₂-CeO₂ |
| 3 | (10) | Ce (6) | 10Y,ZrO₂-CeO₂ |
| 4 | (8) | Mg (6) | 8Y,ZrO₂-MgO |
| 5 | (8) | Ce (3), Mg (3) | 8Y,ZrO₂-Ce,MgO |
| 6 | (8) | Ce (3), Ti (3) | 8Y,ZrO₂-Ce,TiO₂ |
| 7 | (8) | Ce (3), Si (3) | 8Y,ZrO₂-Ce,SiO₂ |
| 8 | (8) | Ca (6) | 8Y,ZrO₂-CaO |

### Preparatory Example 2

### Preparation of Catalyst Ni/(Y,ZrO₂—M)

An aqueous nickel solution was loaded on the support (Y, ZrO₂—M) prepared according to the impregnation method as described in Preparatory Example 1, thereby providing a Ni-based catalyst for the tri-reforming reaction of methane.

In a beaker containing 100 mL of distilled water, the support (Y, M—ZrO₂) prepared in Preparatory Example 1 was added to give slurry. 1M Aqueous solution of nickel nitrate was added to the slurry, and stirred and dried on a hot-plate (60° C.) for 6 h. After dried in an oven (100° C.) for 12 h, the resultant was calcined in air at 1350° C. for 2 h, thereby providing a catalyst Ni/(8Y, ZrO₂—M).

TABLE 2

| | | Amount of nickel | |
|---|---|---|---|
| Catalyst | Support | loading (wt %) | Produced catalyst |
| 1 | 1 | 40 | Ni/(8Y,ZrO₂-CeO₂) |
| 2 | 2 | 40 | Ni/(3Y,ZrO₂-CeO₂) |
| 3 | 3 | 40 | Ni/(10Y,ZrO₂-CeO₂) |
| 4 | 4 | 40 | Ni/(8Y,ZrO₂-MgO) |
| 5 | 5 | 40 | Ni/(8Y,ZrO₂-Ce,MgO) |
| 6 | 6 | 40 | Ni/(8Y,ZrO₂-Ce,TiO₂) |
| 7 | 7 | 40 | Ni/(8Y,ZrO₂-Ce,SiO₂) |
| 8 | 8 | 40 | Ni/(8Y,ZrO₂-CaO) |

### Comparative Preparatory Example

### Preparation of Ni-Based Catalyst (spc—Ni_{0.5}/Mg_{2.5}Al) using a Hydrotalcite Derivative

5 g of Al(NO₃)₃.9H₂O, 9.49 g of Mg(NO₃)₂.6H₂O and 0.63 g of Na₂CO₃ was dissolved in 15 mL of distilled water, respectively. The aqueous solutions of Al(NO₃)₂ and Mg(NO₃)₂ were added dropwisely in the aqueous Na₂CO₃ solution, and stirred for 30 min. 0.89 g of Ni(NO₃)₂.6H₂O dissolved in 15 mL of distilled water was added dropwisely in the aforementioned aqueous solution, followed by stirring for 30 min. 5 M NaOH aqueous solution was added dropwisely until pH 10, thereby forming precipitate, followed by violent agitation for 30 min. This solution was placed at 60° C. for 12 h so that the precipitates might have an improved pseudo-hydrotalcite structure. The resultant precipitate was washed with distilled water till free from hydroxide ion and dried at 80° C. for 1 h.

Thus obtained pseudo-hydrotalcite derivative was calcined in air at 850° C. for 5 h thus preparing Ni-based catalyst in which an active ingredient, i.e. nickel metal, is highly dispersed on the inner surface as well as the outer surface of the support.

The catalyst was ascertained to have Ni_{0.5}/Mg_{2.5}Al formula, having a BET surface area of 197.7 m²·g⁻¹ and a Ni surface area of 13.68 m²·g⁻¹. The analysis using an inductively coupled plasma-emission spectrometer showed that 20 wt % of nickel loading.

### Example 1

### Preparation of Syngas by means of Tri-Reforming Reaction of Methane

The activity of the catalyst was measured by performing the tri-reforming reaction of methane on Ni/(8Y, ZrO₂—CeO₂) catalyst prepared in Preparatory Example 2.

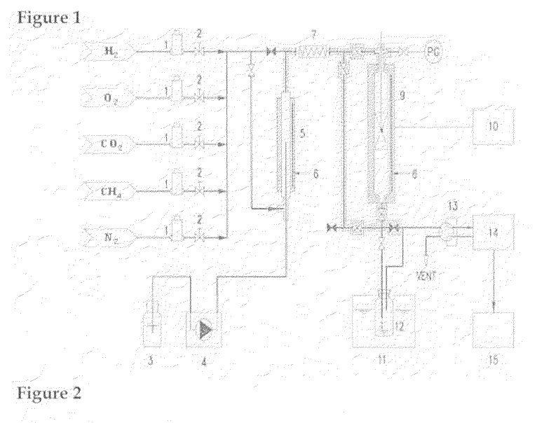

As shown in FIG. 1, the tri-reforming reaction of methane was performed using a conventional reactor with the catalyst. The catalyst was pulverized and sieved using 80-100 mesh sieves. The catalyst with the particle size of 150-250 μm was selected and filled into the reactor, followed by the reduction at 800° C. for 2 h under the hydrogen flow. As a reactant gas, gas mixture mixed with methane, carbon dioxide, steam and oxygen in the volume ratio of 1:1:1:0.1 was supplied into the reactor. The reaction temperature was maintained at 650-850° C. using an electric furnace and a pre-programmed auto-controller. The influx of the reactant gas was controlled at a space velocity of 10,000 h⁻¹ using a mass flow controller, thereby providing syngas.

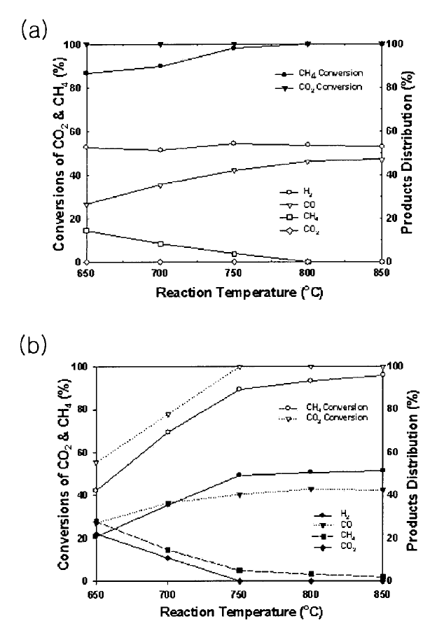

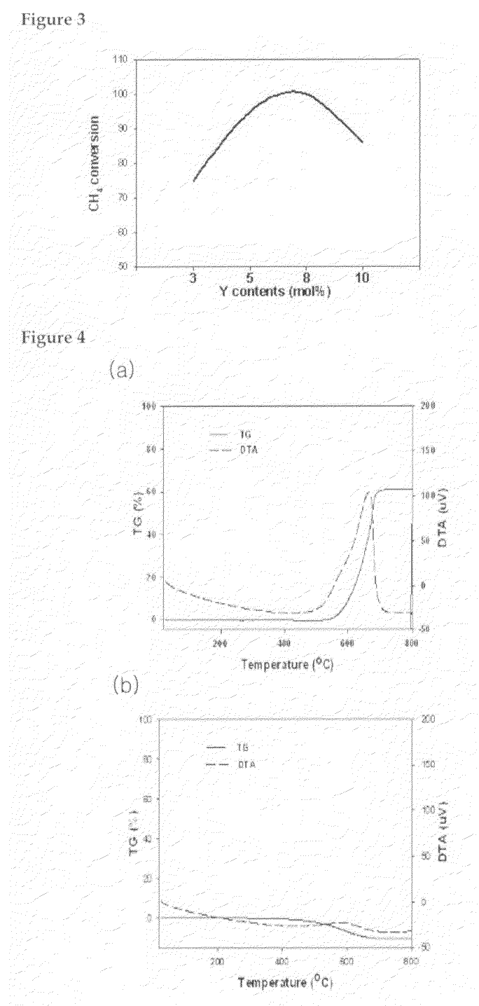

Upon completion of the reaction, the produced gas was subjected to the analysis using a gas chromatograph directly connected to the reactor. Conversion of carbon dioxide and methane was measured under the aforementioned reaction conditions, and the distribution of the produced syngas was also measured as the function of temperature. The result is presented in FIG. 2(a). The conversion was found to increase with the increase in temperature. The conversion of carbon dioxide was 100% over the entire tested temperature range, and the conversion of methane was 100% at 800° C. or above. Further, a long-term experiment for measuring the catalyst durability shows that the catalyst exhibits a constant performance without being deactivated at 800° C. and a space velocity of 10,000 h⁻¹ for 400 h. Examples 2-8

### Preparation of Syngas by means of Tri-Reforming Reaction of Methane

The tri-reforming reaction of methane was performed under the same condition as in Example 1 except that the Ni/(8Y,ZrO₂—CeO₂) catalyst was replaced with each catalyst prepared in Preparatory Example 2. The CH₄ conversion and the CO₂ conversion were measured on each of the aforementioned catalysts, and the result is presented in Table 3.

TABLE 3

| | | Conversion of | Conversion of |
|---|---|---|---|
| Example | Catalyst | CH₄ (%) | CO₂ (%) |
| 1 | Ni/(8Y,ZrO₂-CeO₂) | 100 | 100 |
| 2 | Ni/(3Y,ZrO₂-CeO₂) | 80 | 75 |
| 3 | Ni/(10Y,ZrO₂-CeO₂) | 85 | 96 |
| 4 | Ni/(8Y,ZrO₂-MgO) | 80 | 100 |
| 5 | Ni/(8Y,ZrO₂-Ce,MgO) | 94 | 92 |
| 6 | Ni/(8Y,ZrO₂-Ce,TiO₂) | 92 | 100 |
| 7 | Ni/(8Y,ZrO₂-Ce,SiO₂) | 85 | 62 |
| 8 | Ni/(8Y,ZrO₂-CaO) | 78 | 100 |

As shown in Table 3, almost all the conversions of methane and carbon dioxide were 80% or higher in the tri-reforming reaction of methane on the Ni/(Y,ZrO₂—M) catalyst prepared according to the present invention. Further, the results of Examples 1-3 show that the conversions of methane and carbon dioxide increased as the the yttrium(Y) content increases from 3 mol % to 8 mol %. Moreover, it was investigated how at least one component selected among lanthanum or alkaline earth metal affects on the reactivity in the tri-reforming reaction of methane on the Ni/(8Y—ZrO₂—CeO₂)-based catalyst. The investigation shows that Ni/(8Y—ZrO₂—CeO₂) catalyst prepared in Example 1, Ni/(8Y—ZrO₂—CeO_{2,}TiO₂) catalyst prepared in Example 5 and Ni/(8Y—ZrO₂—Ce, TiO₂) catalyst prepared in Example 6 show relatively superior conversions of methane and carbon dioxide.

### Example 9

### Long-Term Stability through Tri-Reforming Reaction of Methane

The tri-reforming reaction of methane was performed under the same reaction system as in Example 1 at 800° C. and a space velocity of 10,000 h⁻¹ in a molar ratio of methane:carbon dioxide:steam:oxygen of 1:1:1:0.1. In this reaction, the durability and the distribution of products were investigated as the function of the reaction time, and the result is presented in FIG. 6. The distribution of products as a function of reaction time was ascertained to be similarly maintained when the tri-reforming reaction of methane was performed on the Ni/(8Y, ZrO₂—CeO₂)-based catalyst herein for 430 h. The improvement in durability appears to be due to the fact that, as the reaction proceeded, carbons deposited on the surface of catalyst may easily react with oxygen ion supplied by oxidant such as water or air on the surface of the catalyst of CeO₂, a zirconia and nickel because of the action of CeO₂, which is superior in storing or supplying oxygen, thus being easily reacted to as carbon monoxide or carbon dioxide. In the presence of the Ni/(8Y—ZrO₂—CeO₂) catalyst, the conversion of the tri-reforming reaction of methane was higher by about 20% than that of the dry reforming reaction of methane using carbon dioxide.

### Example 10

### Tri-Reforming Reaction of Methane

The tri-reforming reaction of methane was performed under the same reaction system as in Example 1 except that the molar ratio of methane:carbon dioxide:steam:oxygen was changed from 1:1:1:0.1 to 1:0.5:0.5:0.1. At 800° C. and a space velocity of 10,000 h⁻¹, the conversion of carbon dioxide and methane was 95% and 100%, respectively, therey keeping the molar ratio of H₂/CO to at 2.

### Example 11

### Tri-Reforming Reaction of Methane

The tri-reforming reaction of methane was performed under the same reaction system as in Example 10 except that the molar ratios of methane, carbon dioxide, steam and oxygen were changed from 1:1:1:0.1 to 1:1:0.5:0.1, respectively. At 800° C. and a space velocity of 10,000 h⁻¹, the conversion of carbon dioxide and methane was 90% and 95%, respectively, therey keeping the molar ratio of H₂/CO to at 1.4.

Considering the results of Examples 1, 10 and 11, the conversions of methane and carbon dioxide showed little change, as the molar ratios of methane:carbon dioxide:steam:oxygen are changed from 1:0.5:1:0.1 to 1:0.5:0.5:0.1. By controlling the molar ratios of reactant gases as described in aforementioned Examples, syngas was manufactured so that the molar ratio of hydrogen/carbon monoxide (H₂/CO) can be kept at 1-2.

### Comparative Example 1

### Dry Reforming Reaction of Methane

The catalytic activity was measured by performing a dry reforming reaction of methane using carbon dioxide on the Ni/(8Y,ZrO₂—CeO₂) catalyst prepared in Preparatory Example 1.

The typical fixed-bed reactor described in Example 1 was used. The catalyst was pulverized and filled into the reactor before the experiment. Then, the catalyst was reduced at 800° C. for 2 h under the hydrogen flow, and used in the reaction. The mixture of carbon dioxide and methane in the molar ratio of 1:1 was used as a reactant gas. The temperature was controlled in the range of 650-850° C., and the space velocity was maintained to 17,000 h⁻¹ by controlling the flow rate of the reactant gas using a mass flow controller. Upon completion of the reaction, the content of the syngas was subjected to an on-line analysis using a gas chromatograph as described in Example 1. The distribution of products and the conversion of methane and carbon dioxide are shown in FIG. 2(b) as a function of temperature. The conversion of methane and carbon dioxide was found to increase with the increase of temperature. Especially, the conversion of carbon dioxide was 100% at 750° C., while the distribution of products showed little change above 800° C. Although the conversion of methane was relatively high at a temperature greater than 800° C., the catalyst became deactivated seriously as the reaction proceeded. The analysis of the catalyst shows that the deposition of carbon which was the main reason for the deactivation of the catalyst.

After the tri-reforming reaction of methane in Example 1 and the carbon-dioxide reforming reaction of methane in Comparative Example 1 were performed at 800° C. for 20 h. After the completion of the reactions, the thermogravimetry-differential thermal analysis (TG-DTA) was performed on the same Ni/(8Y—ZrO₂—CeO₂) catalyst to ascertain the degree of carbon deposition caused by the aforementioned reaction, and the result is presented in FIGS. 4(a) and 4(b), respectively. The TG-DTA was performed on the catalyst after completing the reforming reaction wherein the temperature of the catalyst was increased from room temperature to 800° C. at a rate of 5° C./min.

As shown in FIG. 4(a), there was hardly any weight change (or a little increase of weight) in the catalyst collected after the tri-reforming reaction of methane, which is a phenomenon that can be found when a metal in the reduced state reacts with oxygen to form an oxide.

In contrast, as shown in FIG. 4(b), more than half of the weight of the catalyst was oxidized at about 630-650° C., resulting in weight loss, after the dry reforming reaction of methane. This result shows that a lot of carbon was deposited on the catalyst after the dry reforming reaction of methane.

### Comparative Example 2

### Tri-Reforming Reaction of Methane on Commercial Catalyst (HT Company)

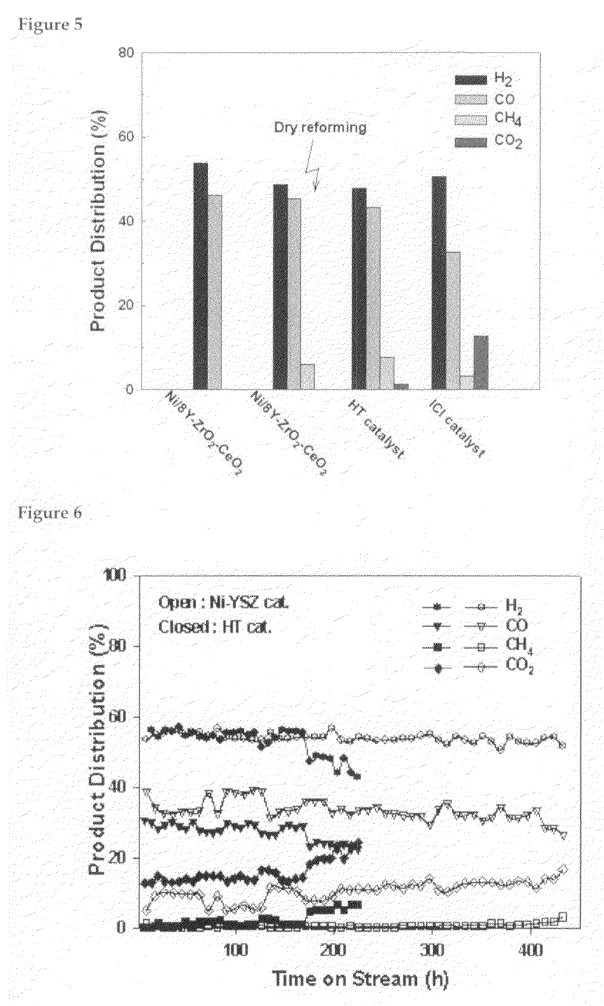

The tri-reforming reaction of methane was performed under the same conditions as described in Example 1 by using the catalyst for steam reforming reaction of methane purchased from HT (Haldor Topsoe) Company, which is known to be superior in the steam reforming reaction of methane. The contents of syngas were presented in FIG. 5, and the durability of catalyst and the distribution of products were presented in FIG. 6.

The Ni-based catalyst herein was superior to the commercial catalyst of HT Company in the steam reforming reaction of methane in terms of the durability and activity of catalyst. Particularly, the Ni-based catalyst herein was twice superior to the commercial catalyst of HT Company in the durability of catalyst as shown in FIG. 6. The tri-reforming reaction of methane was performed for 230 h and 430 h on the catalyst herein and the HT catalyst, respectively. The BET surface area was measured before and after the reaction, and is presented in Table 4. Due to the thermal instability, the HT catalyst showed worse durability than the Ni-based catalyst herein in the tri-reforming reaction of methane. The catalyst became deactivated because the BET surface was decreased as the reaction proceeded.

TABLE 4

BET surface area (m² · g⁻¹)

| Catalyst | before reaction | after reaction |
|---|---|---|
| Ni/(8Y,ZrO₂-CeO₂) | 10.2 | 8.9 |
| HT catalyst | 24.9 | 6.5 |

### Comparative Example 4

### Tri-Reforming Reaction of Methane on spc-Ni_{0.5}Mg_{2.5}Al Catalyst

The tri-reforming reaction of methane was performed on the spc-Ni_{0.5}/Mg_{2.5}Al catalyst prepared in Comparative Preparatory Example (Comparative Catalyst 1) under the same condition as described in Example 1. Only the spc-Ni_{0.5}/Mg_{2.5}Al catalyst with a particle size of 150-250 μm was selected using 80-100 mesh sieves, filled into the reactor and reduced at 750° C. for 2-4 h using 99.999% hydrogen gas before the reaction. The result of the tri-reforming reaction of methane on the catalyst is presented in Table 5.

### Comparative Example 5

### Steam Reforming Reaction of Methane on spc-Ni_{0.5}/Mg_{2.5}Al Catalyst

The steam reforming reaction of methane was performed on the spc-Ni_{0.5}/Mg_{2.5}Al catalyst prepared in Comparative Preparatory Example (Comparative Catalyst 1) under the conditions of 650-850° C., H₂O/CH₄ (S/C) of 3 and a space velocity of 10,000 h⁻¹. Conversion of methane at each temperature is presented in Table 5.

TABLE 5

| | | | Conversion of methane (%) | | | | |
|---|---|---|---|---|---|---|---|
| Comp. | | | temperature (° C.) | | | | |
| Ex. | Reactant gas | Catalyst | 650 | 700 | 750 | 800 | 850 |
| 4 | methane:H₂O | spc-Ni_{0.5}/Mg_{2.5}Al | 8.1 | 32.1 | 51.9 | 81.5 | 93.8 |
| | (S/C = 3.0) | | | | | | |
| 5 | methane:CO₂:H₂O:O₂ = | spc-Ni_{0.5}/Mg_{2.5}Al | 59.2 | 65.3 | 73.8 | 84.5 | 91.4 |
| | 1:1:1:0.1 | | | | | | |

As shown in FIG. 5, the tri-reforming reaction of methane showed a higher conversion rate than the steam reforming reaction of methane at low temperature range. At a temperature greater than 800° C., the steam reforming reaction of methane and the tri-reforming reaction of methane showed similar conversions of methane. As comparing the results of Example 1, the Ni-based catalyst herein was ascertained to be superior to the spc-Ni_{0.5}/Mg_{2.5}Al catalyst in terms of the catalytic activity to the tri-reforming reaction of methane over entire temperature range. From the aforementioned results, it was ascertained that the tri-reforming reaction of methane is effective in reforming methane at a relatively lower temperature and that the Ni/(8Y, ZrO₂—M) catalyst herein is appropriate.

Comparative Examples and Examples above show that a catalyst may not show equivalent effect in various reforming reactions of hydrocarbon because the conversion of the hydrocarbon, the distribution of products and the activity of the catalyst may vary depending on the kind of the hydrocarbon and the reforming reaction. Particularly, the present invention provides Ni-based catalyst Ni/(8Y,ZrO₂—M), which is superior in manufacturing syngas through a tri-reforming reaction of methane. The present invention also provides optimized conditions for selectively controlling a H₂/CO molar ratio.

As described above, when zirconia is doped with yttrium and lanthanum and/or alkaline earth metal, the lattice of the zirconia is deformed, thus preventing lattice deformation due to the change of temperature and enabling the use of zirconia support at high temperature. The tri-reforming reaction of methane, when performed using the catalyst where a nickel active metal supported in the stabilized zirconia support, shows an increase in conversion of methane by about 20% especially as compared to the dry reforming reaction of methane. Moreover, carbon deposition is inhibited to improve the catalyst deactivation and the molar ratio of hydrogen and carbon monoxide (H₂/CO) in syngas may also be selectively controlled. Thus obtained syngas may be usefully utilized in preparing dimethyl ether (DME), methanol and higher alcohol. The Ni-based catalyst for the tri-reforming reaction of methane according to the present invention shows superior to the commercial HT catalyst for steam reforming reaction of methane at the same conditions as well as having a twice long durability, thus being suitable in producing syngas using waste gases from a fine chemical process, a petrochemical process, a thermal power plant and a cement plant.

What is claimed is:

1. A Ni-based catalyst of Formula (1) for the tri-reforming reaction of methane, wherein a nickel metal is supported on a zirconia support doped with yttrium (Y) and a metal selected from the group consisting of a lanthanum and an alkaline earth metal:
Ni/(Y,ZrO₂—M) (1)
wherein Ni is an active metal and contained in the amount of 0.5-10 wt % relative to ZrO₂; Y is an essential metal for doping the zirconia and contained in the amount of 5-10 mol % relative to the zirconia; and M is at least one metal selected from the group consisting of an lanthanum and an alkaline earth metal and contained for doping zirconia in the amount of 0.5-10 wt % relative to the zirconia.

2. The Ni-based catalyst of claim 1, wherein the nickel is contained in the amount of 0.5-2 wt % relative to the zirconia.

3. The Ni-based catalyst of claim 1, wherein the M is contained in the amount of 1.5-3 wt % relative to the zirconia.

4. A process for producing syngas, which comprises the step of performing a tri-reforming reaction of methane by supplying a mixture of carbon dioxide, steam and oxygen over the Ni-based catalyst according to claim 1 under the conditions of 650-850° C., 0.5-10 atm and 1,000-300,000 h⁻¹ of space velocity.

5. The process of claim 4, wherein 0.5-2.0 moles of carbon dioxide, 0.05-1.0 moles of oxygen and 0.5-2.0 moles of the steam are supplied relative to 1 mole of the methane.

6. The process of claim 4, wherein the molar ratio of hydrogen to carbon monoxide in the syngas is 1 to 0.5-2.0.

7. A process for producing syngas, which comprises the step of performing a tri-reforming reaction of methane by supplying a mixture of carbon dioxide, steam and oxygen over the Ni-based catalyst according to claim 2 under the conditions of 650-850° C., 0.5-10 atm and 1,000-300,000 h⁻¹ of space velocity.

8. A process for producing syngas, which comprises the step of performing a tri-reforming reaction of methane by supplying a mixture of carbon dioxide, steam and oxygen over the Ni-based catalyst according to claim 3 under the conditions of 650-850° C., 0.5-10 atm and 1,000-300,000 h⁻¹ of space velocity.
